(19) United States
(12) Patent Application Publication
(10) Pub. No.: US 2014/0260554 A1
(43) Pub. Date: Sep. 18, 2014

(54) Leak Detector

(71) Applicant: Colder Products Company, St. Paul, MN (US)

(72) Inventor: William J. Rankin, Burnsville, MN (US)

(21) Appl. No.: 14/209,533

(22) Filed: Mar. 13, 2014

Related U.S. Application Data
(60) Provisional application No. 61/798,582, filed on Mar. 15, 2013.

(51) Int. Cl. G01M 3/40

(52) U.S. Cl. CPC G01M 3/40
USPC 73/46

(57) ABSTRACT

An example leak detector assembly includes: a leak detection device, including: a main body; and a plurality of electrical filaments extending across the main body, each of the electrical filaments being configured to detect fluid from a leak and thereupon deliver an electrical current.

### BACKGROUND

Coupling assemblies typically include female and male couplings that are connected to create a fluid flow path therebetween. Such coupling assemblies can be used in various applications, including biomedical applications, beverage dispensing, instrument connections, photochemical handling, liquid cooling of electronic devices, and others. It is possible for leaks to occur in such systems. Depending on the types of fluids that are in the fluid flow path, such leaks can result in damage, monetary losses, and health concerns when such fluids are caustic to humans.

### SUMMARY

In one non-limiting aspect, a leak detector assembly includes: a leak detection device, including: a main body; and a plurality of electrical filaments extending across the main body, each of the electrical filaments being configured to detect fluid from a leak and thereupon deliver an electrical current.

In another non-limiting aspect, a system includes: a leak detection assembly including a plurality of leak detection devices, each of the leak detection devices including: a main body; and a plurality of electrical filaments extending across the main body, each of the electrical filaments being configured to detect leaks; and a fluid system including a plurality of fluid conduits; wherein the leak detection devices are positioned about the fluid conduits to detect fluid from a leak and thereupon deliver an electrical current.

In yet another non-limiting aspect, a method for detecting leaks in a fluid system includes: positioning a leak detection device about a portion of the fluid system, the leak detection device including a main body, and a plurality of electrical filaments extending through the main body, each of the electrical filaments being configured to detect fluid from a leak; allowing the leak detection device to detect the fluid from the leak; and transmitting a signal from the leak detection device in response to detecting the fluid.

### DESCRIPTION OF THE DRAWINGS

Reference is now made to the accompanying drawings, which are not necessarily drawn to scale.

FIG. 1 is a schematic view of an example system including a fluid flow assembly and a leak detection assembly.

FIG. 2 is a schematic view of an example leak detection device of the system of FIG. 1.

FIG. 3 is a schematic view of another example system including a fluid flow assembly and a leak detection assembly.

### DETAILED DESCRIPTION

The present disclosure relates to a leak detection assembly for a fluid flow assembly. In some examples the leak detection assembly is configured to detect a leak in the fluid flow assembly. In other examples, the leak detection assembly is further configured to alert when a leak is detected. Additional details about these examples are provided below.

Referring now to FIG. 1, an example system 100 is shown. In this system 100, an example fluid flow assembly 101 and an example leak detection assembly 103 are depicted.

The fluid flow assembly 101 includes a first fluid conduit 102 coupled to a first coupling device 110. The first coupling device 110 is coupled to a second coupling device 120. The second coupling device 120 is, in turn, coupled to a second fluid conduit 104.

The fluid flow assembly 101 thereby forms a passageway for a fluid that is transferred between two points through the first and second fluid conduits 102, 104 and the first and second coupling devices 110, 120.

In this example, the first and second coupling devices 110, 120 are quick disconnect couplings. One example of a quick disconnect coupling assembly is described in U.S. Pat. No. 5,033,777 to Blenkush, the entirety of which is hereby incorporate by reference. In other embodiments, other types of coupling devices and configurations can be used to form the fluid flow assembly 101. For example, more coupling devices and/or fluid conduits can be used to connect multiple points in the fluid flow assembly 101.

The leak detection assembly 103 includes leak detection devices 132, 134. The leak detection device 132 is generally positioned to surround at least a portion of the first fluid conduit 102, and the leak detection device 134 is generally positioned to surround at least a portion of the second fluid conduit 104. Although only two leak detection devices are depicted, more or fewer devices can be used. Further, the leak detection devices 132, 134 can be positioned at strategic locations along the first and second fluid conduits 102, 104, or be configured to extend along an entirety of the first and second fluid conduits 102, 104.

The leak detection devices 132, 134 are generally configured to detect any leaks that occur from the first and second fluid conduits 102, 104, as described further below. In this example, when one or both of the leak detection devices 132, 134 detect a leak, the leak detection devices 132, 134 communicate with a node 140 via electrical conduits 133. In this example, the leak detection devices 132, 134 communicate the detection of a leak. Optionally, the leak detection devices 132, 134 and/or the node 140 can be configured to estimate and communicate a magnitude and/or location of the leak.

The node 140 is programmed to receive the signals from the leak detection devices 132, 134 via the electrical conduits 133. When such a signal is received, the node 140 communicates the receipt of the signal to a central node 150, using wired or wireless (as depicted in the example shown) technologies.

The central node 150 is programmed with logic to receive the signal and to act thereupon. For example the central node 150 can display a location diagram illustrating where the leak occurred. Further, the central node 150 can include alarming logic that allows the central node 150 to escalate an alarm to various personnel through audible, visual, and/or digital methods. For example, when a leak signal is detected, the central node 150 can generate a message (e.g., a text message or an email) to appropriate personnel to address the situation. If not resolved or reset in a certain time period, the central node 150 can continue to escalate the issue by contacting other personnel in a choreographed process.

In some examples, multiple nodes 140 are positioned throughout a location. Each of the nodes 140 communicates with the central node 150. In other embodiments, a central node 150 is not required, particularly for smaller locations. In those instances, the node 140 can perform one or all of the tasks of the central node 150.

Referring now to FIG. 2, the leak detection device 132 is shown in greater detail. In this example, the leak detection device 132 includes a main body 201 that is deformable. Specifically, the main body 201 can be formed into a loop to encompass one or more fluid conduits, such as illustrated in FIG. 1. One or more fasteners can be provided to maintain the main body 201 in the loop upon the fluid conduits. In other embodiments, the leak detection device 132 can be formed as a tube, either rigid or deformable. Such a tube can be slid onto the fluid conduit.

The main body 201 can be made of an absorbing and/or wicking material. In one example, the main body 201 is made of a wicking material such as Quick Dry manufactured by Sportingtex of Taiwan. Other similar materials can be used. In function, the material is configured to deliver the fluid to components on or in the material, as described further below.

Positioned along the main body 201 of the leak detection device 132 is a plurality of electrical filaments 210. In one example, each of the electrical filaments 210 extends generally from a first end 202 to a second end 204 of the main body 201. Other configurations are possible, such as forming a weave pattern and/or having each filament 210 only extend along a portion of the main body 201.

In one example, the leak detection device 132 is positioned on a fluid conduit such that the filaments 210 run circumferentially about the fluid conduit. In other examples, the leak detection device 132 can be positioned generally opposite to that, so that the filaments 210 run axially relative to the conduit. Variations are possible.

In this example, each of the filaments 210 is configured to conduct an electrical current. Specifically, an electric current is run through each of the filaments 210, essentially creating a plurality of open circuits.

When fluid is present on the main body 201 of the leak detection device 132, the main body 201 generally directs the fluid to the filaments 210. For example, the wicking nature of the main body 201 causes the fluid to be directed to the filaments 210.

If enough fluid is present, the fluid causes a short between two or more adjacent filaments 210 on the main body 201. This short results in a closed circuit that allows current to flow, as described below.

Specifically, once the fluid causes the short between adjacent filaments 210, the current supplied by the electrical conduit 133 is returned to the node 140 via a return path in the electrical conduit 133. This complete circuit signals to the node 140 that a leak has been detected. As noted, the node 140 can detect the electric current on the electrical conduits 133 and respond appropriately.

In other examples, a passive or powered amplifier is provided on the leak detection device 132 to amplify the signal that is transmitted from the electrical filaments 210 to the node 140.

In one example, the filaments 210 are thin copper wires that conduct electricity. One example of such a wire is 299/3 SV005 Buss Wire by Alpha Wire of Elizabeth, N.J. Many other similar materials can be used.

Referring now to FIG. 3, another example system 300 is shown. The system 300 is similar to the system 100 described above, except the system 300 also includes a leak detection device 136 positioned about the first and second coupling devices 110, 120.

The leak detection device 136 functions in a manner similar to leak detection devices 132, 134, except the leak detection device 136 is positioned about the first and second coupling devices 110, 120, where a leak may be more likely to occur. The leak detection device 136 is coupled via another electrical conduit 133 to the node 140. Should fluid be detected, the leak detection device 136 would return the electric current on the electrical conduit 133 to notify the node 140.

Although a single leak detection device 136 is depicted, in another design, a separate leak detection device can be provided for each of the first and second coupling devices 110, 120. This may facilitate for easier uncoupling of the first and second coupling devices 110, 120 without having to remove or displace the leak detection devices. In addition, although fluid conduits and coupling devices are depicted, the fluid detection devices can be used to detect leaks for other components, such as fittings, pumps, radiators, or electronics cooling cold plates.

Further, although a wired connection is depicted between each of the leak detection devices 132, 134, 136, in alternative designs, other modes of communication can be used, such as wireless technologies like RF, Bluetooth and ZigBee.

In some examples, the electric signals that are communicated by the leak detection devices uniquely identify the leak detection device so that a location of the leak can be determined. In other examples, the node 140 determines which electrical conduit 133 provides the signal and determines a location of the leak in this manner. The location information can be transferred to the node 140 for alerting purposes.

In the examples shown, the nodes 140, 150 are computing devices that each includes one or more processing units and computer readable media. Computer readable media includes physical memory such as volatile memory (such as RAM), non-volatile memory (such as ROM, flash memory, etc.) or some combination thereof. Additionally, the computing devices can include mass storage (removable and/or non-removable) such as a magnetic or optical disks or tape. An operating system, such as Linux or Windows, and one or more application programs can be stored on the mass storage device. The computing devices can include input devices (such as a keyboard and mouse) and output devices (such as a monitor and printer).

The computing devices also include network connections to other devices, computers, networks, servers, etc. In example embodiments, the computing devices communicate with one another through one or more networks, such as a local area network (LAN), a wide area network (WAN), the Internet, or a combination thereof. Communications can be implemented using wired and/or wireless technologies.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A leak detector assembly, comprising:
a leak detection device, including:
a main body; and
a plurality of electrical filaments extending across the main body, each of the electrical filaments being configured to detect fluid from a leak and thereupon passing an electrical current.

2. The leak detector assembly of claim 1, wherein the electrical current is transmitted to a node, the node being configured to detect the electrical current.

3. The leak detector assembly of claim 2, wherein the node is configured to transmit detection of the leak to a central node.

4. The leak detector assembly of claim 3, wherein the node transmits a location of the leak to the central node.

5. The leak detector assembly of claim 3, wherein the central node is configured to generate an alert.

6. The leak detector assembly of claim 5, wherein the alert identifies a location of the leak.

7. A system comprising:
a leak detection assembly including a plurality of leak detection devices, each of the leak detection devices including:
a main body; and
a plurality of electrical filaments extending across the main body, each of the electrical filaments being configured to detect leaks; and
a fluid system including a plurality of fluid conduits;
wherein the leak detection devices are positioned about the fluid conduits to detect fluid from a leak and thereupon complete an electronic circuit.

8. The system of claim 7, wherein the electrical current is transmitted to a node, the node being configured to detect the electrical current.

9. The system of claim 8, wherein the node is configured to transmit detection of the leak to a central node.

10. The system of claim 9, wherein the node transmits a location of the leak to the central node.

11. The system of claim 9, wherein the central node is configured to generate an alert.

12. The system of claim 11, wherein the alert identifies a location of the leak.

13. The system of claim 7, wherein the fluid system further includes a plurality of coupling devices, and wherein at least some of the leak detection devices are positioned about the coupling devices.

14. The system of claim 13, wherein the coupling devices include quick disconnect couplings.

15. A method for detecting leaks in a fluid system, the method comprising:
positioning a leak detection device about a portion of the fluid system, the leak detection device including a main body, and a plurality of electrical filaments extending through the main body, each of the electrical filaments being configured to detect fluid from a leak;
allowing the leak detection device to detect the fluid from the leak; and
completing an electronic circuit to transmit electrical current from the leak detection device in response to detecting the fluid.

16. The method of claim 15, further comprising configuring a node to which the signal is sent to detect the electrical current.

17. The method of claim 16, further comprising transmitting the signal from the node to a central node.

18. The method of claim 17, further comprising transmitting an identifier of a location of the leak with the signal.

19. The method of claim 16, further comprising generating an alert by the central node.

20. The method of claim 15, further comprising identifying a location of the leak.
